(19) United States
(12) Patent Application Publication
(10) Pub. No.: US 2010/0172298 A1
(43) Pub. Date: Jul. 8, 2010

(54) APPARATUS AND METHOD FOR SUPPORTING MOBILITY OF SENSOR NODE IN IP-BASED SENSOR NETWORKS

(75) Inventors: Myung Ki Shin, Daejeon (KR); Hyoung Jun Kim, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon (KR)

(21) Appl. No.: 12/664,434

(22) PCT Filed: Mar. 21, 2008
(86) PCT No.: PCT/KR08/01592

§ 371 Date: Dec. 14, 2009

(30) Foreign Application Priority Data
Jul. 26, 2007 (KR) 10-2007-0075294

(51) Int. Cl. H04W 8/02

(52) U.S. Cl. 370/328

(57) ABSTRACT

A method and apparatus for managing mobility of a sensor node in an Internet Protocol (IP)-based sensor network including a plurality of personal area networks (PANs) is provided. The apparatus for managing mobility of a sensor node in a personal area network (PAN), the apparatus including: a sensor node sensing unit to sense a sensor node moving into the PAN from another PAN; a proxy binding update (PBU) message generation unit to generate location change information of the sensed sensor node; and a PBU message transmission unit to transmit the location change information.

### TECHNICAL FIELD

The present invention relates to an Internet Protocol (IP)-based sensor network, and more particularly, to a method and apparatus for managing mobility of a sensor node in an Internet Protocol (IP)-based sensor network including a plurality of personal area networks (PANs).

This work was supported by the IT R&D program of MIC/IITA. [2007-P10-07, USN networking and application technology standards development]

### BACKGROUND ART

Generally, only moving within a single personal area network (PAN) using an ad-hoc mode has been considered in terms of mobility support of a sensor node. However, a need for an Internet Protocol (IP)-based sensor dramatically increases and technologies required for continuous IP mobility when a sensor node moves between an arbitrary PAN and another PAN increase. An IP mobility support scheme such as a widely used Mobile IP scheme may be applied for an IP-based mobility support of a sensor node.

When a Mobile IP scheme is applied to a terminal such as a sensor node including a diminutive memory and battery, signaling to process an additional software upgrade and binding update for supporting a Mobile IP in a sensor node frequently occurs. Accordingly, various disadvantages such as battery consumption may be caused.

### DISCLOSURE OF INVENTION

### Technical Problem

The present invention provides a method and apparatus which applies a proxy Mobile Internet Protocol (IP) scheme instead of a Mobile IP scheme, and thereby may support mobility of a sensor node between a personal area network (PAN) and another PAN without battery consumption caused by excessive signaling and additional software upgrades for the mobility support.

### Technical Solution

According to an aspect of the present invention, there is provided an apparatus for managing mobility of a sensor node in a personal area network (PAN), the apparatus including: a sensor node sensing unit to sense a sensor node moving into the PAN from another PAN; a proxy binding update (PBU) message generation unit to generate location change information of the sensed sensor node; and a PBU message transmission unit to transmit the location change information.

According to another aspect of the present invention, there is provided an apparatus for managing mobility of a sensor node in a PAN, the apparatus including: a location change information receiving unit to receive location change information of the sensor node from a coordinator node controlling the PAN; a location information management unit to update location information of the sensor node according to the location change information; and an external IP data transceiving unit to transmit external IP data to the coordinator node according to the updated location information.

According to an aspect of the present invention, there is provided a method of managing mobility of a sensor node in an IP-based PAN, the method including: sensing a sensor node which moves into the PAN from an arbitrary PAN; and generating and transmitting location change information of the sensed sensor node.

According to another aspect of the present invention, there is provided a method of managing mobility of a sensor node which moves from an arbitrary PAN to another PAN, the method including: receiving location change information of the sensor node; updating location information of the sensor node based on the location change information; and transmitting external IP data to a coordinator node, which controls the sensor node, by referring to the updated location information.

### ADVANTAGEOUS EFFECTS

According to the present invention, when sensor nodes move into another PAN from a PAN in which each of the sensor nodes is located, a coordinator node in the other PAN senses the movement of the sensor node, and transmits a PBU instead of the sensor node to an LMA, and the like, without excessive signaling such as a binding update controlled by the sensor node in a Mobile IP scheme in a conventional art. Accordingly, in terms of mobility management between PANs of the sensor node, the signaling for mobility management may be excluded in the sensor node and mobility between PANs may be provided in the sensor node without battery consumption caused by the excessive signaling and additional software upgrades for the mobility management in the sensor node.

### BRIEF DESCRIPTION OF THE DRAWINGS

FIG. 1 is a diagram illustrating an example of movement of a sensor node in an Internet Protocol (IP)-based sensor network including a plurality of personal area networks (PANs) according to an embodiment of the present invention;

FIG. 2 is a diagram illustrating a configuration of an IP-based sensor network system for managing mobility of a sensor node according to an embodiment of the present invention;

FIG. 3 is a diagram illustrating a configuration of a coordinator node according to an embodiment of the present invention;

FIG. 4 is a diagram illustrating a configuration of a local mobility anchor (LMA) according to another embodiment of the present invention;

FIG. 5 is a diagram illustrating a method of managing mobility of a sensor node in an IP-based sensor network according to an embodiment of the present invention;

FIG. 6 is a diagram illustrating an example of transmitting external IP data to a sensor node which moves from an arbitrary PAN to another PAN according to an embodiment of the present invention;

FIG. 7 is a diagram illustrating an example of transmitting external IP data from a coordinator node to a sensor node according to another embodiment of the present invention; and

FIG. 8 is a diagram illustrating a method of transmitting external IP data to a sensor node which moves from an arbitrary PAN to another PAN according to another embodiment of the present invention.

### MODE FOR THE INVENTION

In the present invention, a Proxy Mobile Internet Protocol (IP) scheme is applied to manage mobility of sensor nodes in an Internet Protocol (IP)-based sensor network, and sensor nodes which move such as a full-function device (FFD) and reduced-function device (RFD) do not additionally use a mobility management protocol. An IP-based sensor network and method where only a coordinator node controlling a personal area network (PAN), such as a coordinator-function device (CFD), senses and registers movement of sensor nodes in the PAN and performs proxy binding update (PBU) signaling for mobility management instead of the sensor node, is provided. The sensor node and coordinator node can be determined when designing a network. It is assumed that the CFD does not move.

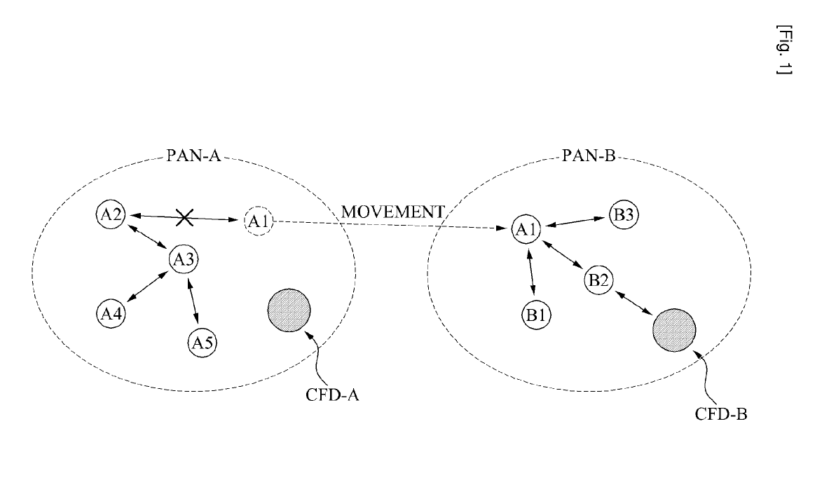

FIG. 1 is a diagram illustrating an example of movement of a sensor node in an IP-based sensor network including a plurality of PANs according to an embodiment of the present invention.

Referring to FIG. 1, a sensor network area which is a PAN, hereinafter, PAN-A, includes a coordinator node, hereinafter, CFD-A, and RFD and FFD sensor nodes such as A1, A2, A3, A4, and A5. Another sensor network area, hereinafter, PAN-B, includes a coordinator node, hereinafter, CFD-B, and RFD and FFD sensor nodes such as B1, B2, and B3. It is illustrated that sensor node A1 moves from PAN-A to PAN-B in FIG. 1.

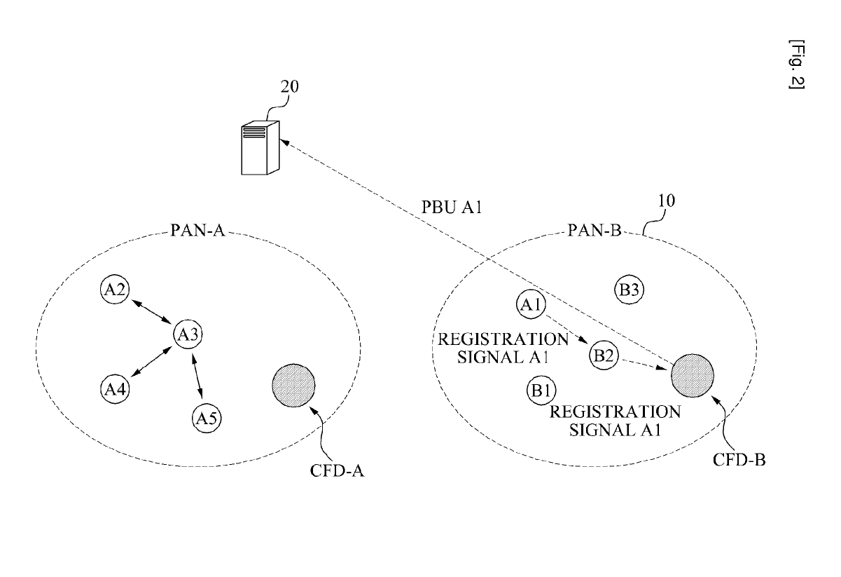

FIG. 2 is a diagram illustrating a configuration of an IP-based sensor network system for supporting mobility of a sensor node according to an embodiment of the present invention.

Referring to FIG. 2, the IP-based sensor network system includes PAN-B 10 and local mobility anchor (LMA)-A 20. PAN-B 10 senses sensor node A1 which moves into PAN-B 10, and transmits a PBU message. LMA-A 20 updates binding cache information of sensor node A1 based on the PBU message.

As described above, PAN-B 10 includes sensor node A1 and coordinator node CFD-B. Sensor node A1 transmits a registration signal to coordinator node CFD-B controlling PAN-B 10. Coordinator node CFD-B senses sensor node A1 through the registration signal, generates the PBU message, and transmits the PBU message to LMA-A 20.

When moving into PAN-B 10, sensor node A1 retrieves coordinator node CFD-B of PAN-B 10 using an existing ad-hoc routing protocol such as an ad hoc on-demand distance vector (AOVD) or dynamic mobile ad hoc network (MANET) on-demand (DYMO), and attaches sensor node A1 to PAN-B 10. The retrieving operation is not included in a Mobile IP scheme in a conventional art. The AOVD or DYMO is used to retrieve an optimal path for transceiving data among sensor nodes in a single PAN, and may be installed in a node for routing among sensor nodes. In the present invention, the AOVD or DYMO is used to retrieve a coordinator node controlling a new PAN when a sensor node moves into the new PAN. Sensor node A1 retrieves an optimal path to coordinator node CFD-B of PAN-B 10 via sensor node B2 in PAN-B 10, and registers sensor node A1. Accordingly, coordinator node CFD-B of PAN-B 10 senses that sensor node A1 moves into PAN-B 10 that is controlled by coordinator node CFD-B, and transmits a PBU message to LMA-A 20 controlling PAN-A. Thus, LMA-A 20 recognizes that sensor node A1 moves to PAN-B 10 from PAN-A, and stores a binding cache. The binding cache indicates information about the recognition, and includes identification information about sensor node A1 and a PAN including coordinator node CFD-B.

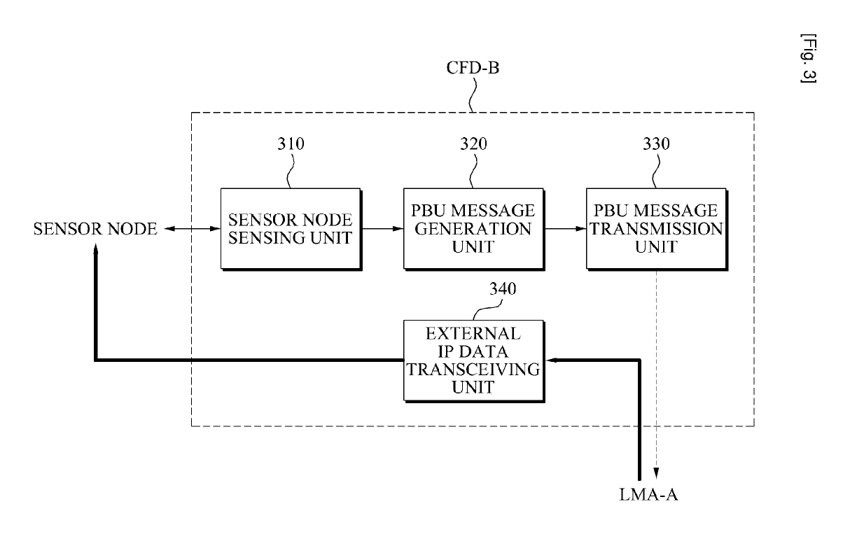

FIG. 3 is a diagram illustrating a configuration of a coordinator node according to an embodiment of the present invention.

Referring to FIG. 3, coordinator node CFD-B includes a sensor node sensing unit 310, a PBU message generation unit 320, and a PBU message transmission unit 330. The sensor node sensing unit 310 senses sensor node A1 moving into PAN-B 10 from PAN-A. The PBU message generation unit 320 generates location change information, that is, PBU message, of the sensed sensor node A1. The PBU message transmission unit 330 transmits the location change information to LMA-A 20 and updates binding cache information.

The sensor node sensing unit 310 senses sensor node A1 using an ad hoc protocol.

Specifically, coordinator node CFD-B may further include an external IP data transceiving unit to receive external IP data from LMA-A 20 and transmit the external IP data to sensor node A1.

An external IP data transceiving unit 340 decapsulates the received external IP data, retrieves an optimal path using the ad hoc routing protocol again, and transmits the external IP data to sensor node A1.

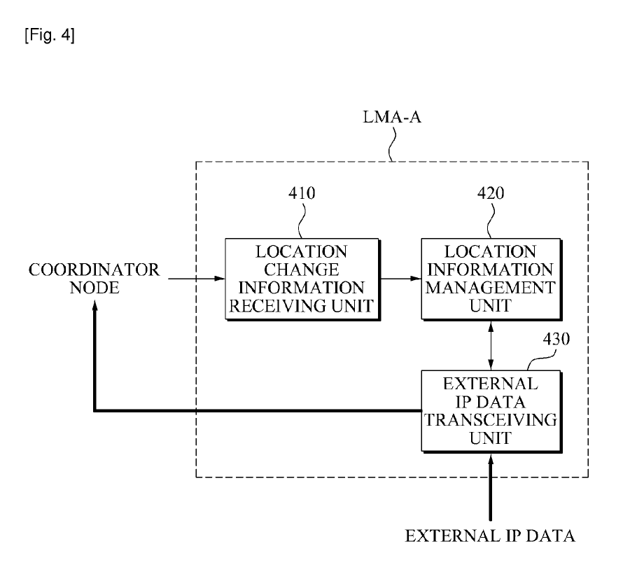

FIG. 4 is a diagram illustrating a configuration of LMA-A 20 according to another embodiment of the present invention.

Referring to FIG. 4, LMA-A 20 includes a location change information receiving unit 410, a location information management unit 420, and an external IP data transceiving unit 430. The location change information receiving unit 410 receives location change information of sensor node A1 from coordinator node CFD-B controlling PAN-B 10. The location information management unit 420 updates location information of sensor node A1 according to the location change information. The external IP data transceiving unit 430 transmits external IP data to coordinator node CFD-B according to the updated location information.

The location information management unit 420 updates cache information of binding cache information managing the location information of sensor node A1. Accordingly, LMA-A 20 may control sensor node A1 moving into PAN-B 10.

The external IP data transceiving unit 430 may recognize that sensor node A1 is located in PAN-B 10, not PAN-A, through the binding cache information. Accordingly, the external IP data transceiving unit 430 no longer transmits the external IP data to PAN-A and transmits the external IP data to coordinator node CFD-B in PAN-B 10 through an IP-in-IP tunneling. The IP-in-IP tunneling is defined in a proxy Mobile IP.

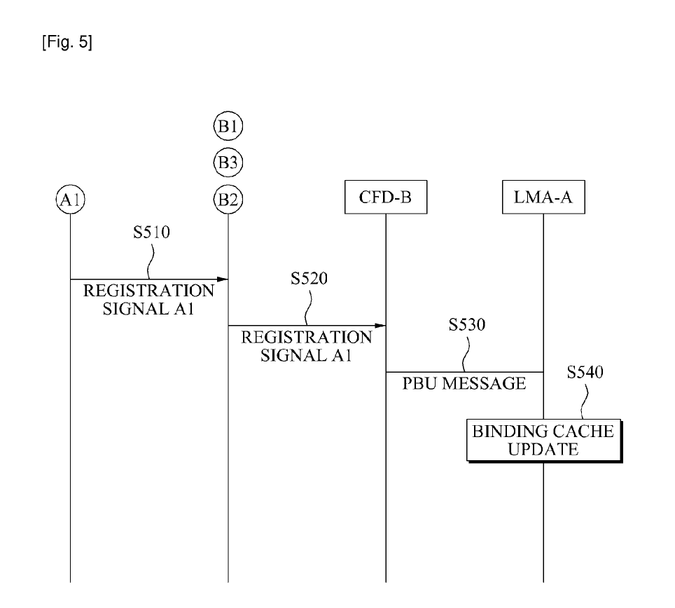

FIG. 5 is a diagram illustrating a method of managing mobility of a sensor node in an IP-based sensor network according to an embodiment of the present invention.

Referring to FIG. 5, the method of managing mobility of a sensor node includes sensing sensor node A1 moving into a PAN from an arbitrary PAN in operations 5510 and 5520, and generating and transmitting location change information (PBU message) of sensor node A1 in operations 5530 and 5540.

Specifically, when sensor node A1 moves as illustrated in FIGS. 1 and 2, coordinator node CFD-B recognizes that sensor node A1 moves into the PAN that is controlled by coordinator node CFD-B according to a signaling process, that is, the method of managing mobility of a sensor node of FIG. 5. Coordinator node CFD-B transmits information about the movement of sensor node A1 to LMA-A 20, and LMA-A 20 recognizes sensor node A1 moves into PAN-B 10. Specifically, in operation 5510, sensor node A1 broadcasts a registration signal to retrieve coordinator node CFD-B to neighbor sensor nodes B1, B2, and B3. Neighbor sensor nodes B1, B2, and B3 are adjacent to sensor node A1. In operation 5520, neighbor sensor node B2 receiving the registration signal transmits the registration signal to coordinator node CFD-B again, since neighbor sensor node B2 is an optimal path to coordinator node CFD-B. Neighbor sensor node B2 may know neighbor sensor node B2 is the optimal path to coordinator node CFD-B using an ad hoc routing protocol. Through the operations above, coordinator node CFD-B recognizes sensor node A1 moves into the PAN, and transmits a PBU message to LMA-A 20 controlling mobility of the PAN-A in operation 5530. The PBU message is provided by a proxy Mobile IP. In operation S540, through the operations above, LMA-A 20 updates cache information of binding cache information, and thus LMA-A 20 may manage sensor node A1 moving into PAN-B.

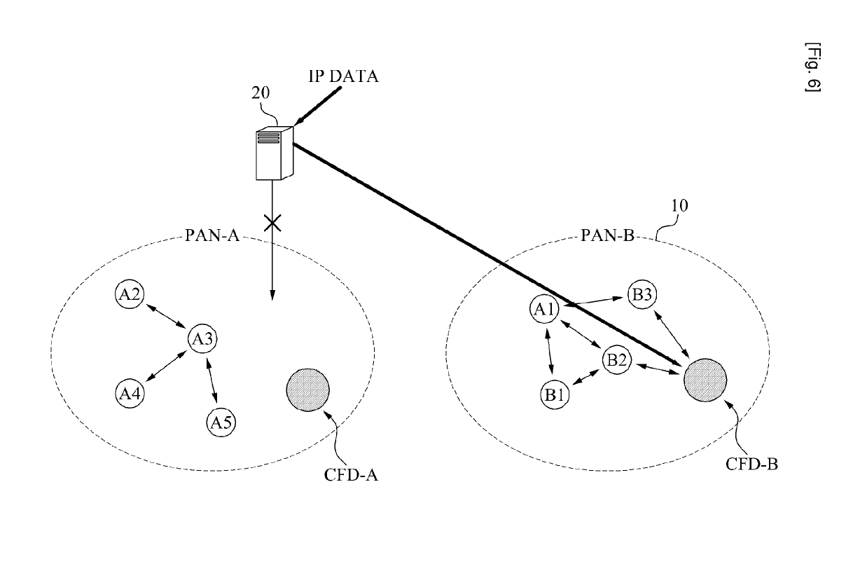

FIG. 6 is a diagram illustrating an example of transmitting external IP data to a sensor node which moves from an arbitrary PAN to another PAN according to an embodiment of the present invention.

Referring to FIG. 6, external IP data transmitted to sensor node A1 is received via LMA-A 20. In this instance, LMA-A 20 may recognize that sensor node A1 is currently located in PAN-B, not PAN-A, through binding cache information. Accordingly, the external IP data is no longer transmitted to PAN-A, and transmitted to coordinator node CFD-B in PAN-B.

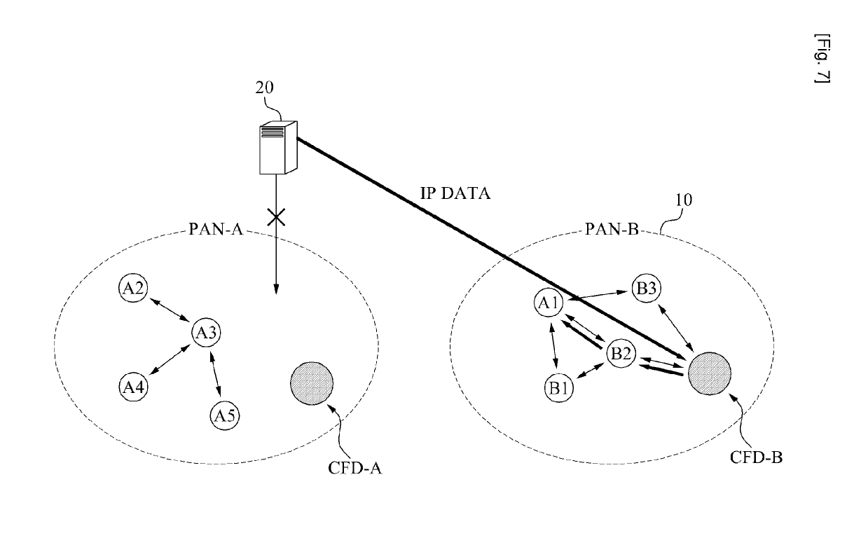

FIG. 7 is a diagram illustrating an example of transmitting external IP data from a coordinator node to a sensor node according to another embodiment of the present invention.

Referring to FIG. 7, coordinator node CFD-B decapsulates the received external IP data. Also, coordinator node CFD-B retrieves an optimal path using an ad hoc routing protocol and transmits the external IP data to sensor node A1.

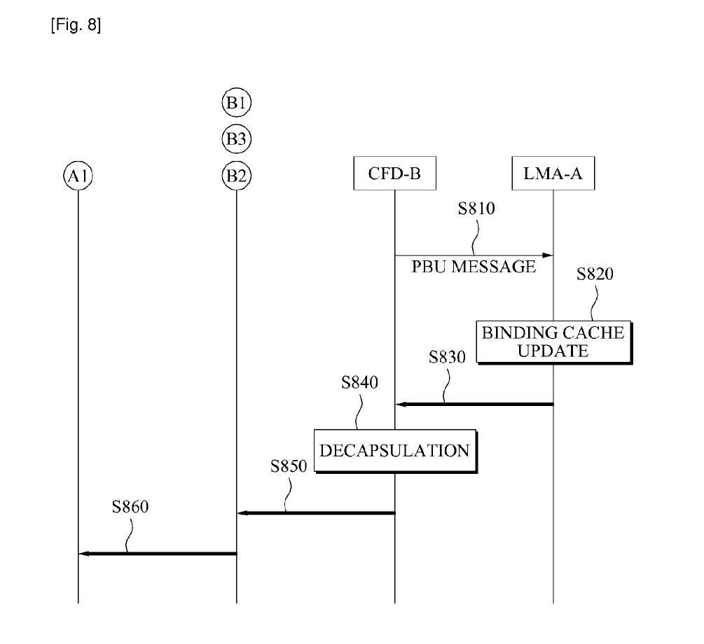

FIG. 8 is a diagram illustrating a method of transmitting external IP data to a sensor node which moves from an arbitrary PAN to another PAN according to another embodiment of the present invention.

Referring to FIG. 8, the method of transmitting external IP data to a sensor node includes receiving location change information (PBU message) of sensor node A1 in operation 5810, updating location information of sensor node A1 based on the location change information in operation 5820, and transmitting external IP data to coordinator node CFD-B that controls sensor node A1, by referring to the updated location information in operations 5830, 5840, 5850, and 5860.

Specifically, the external IP data transmitted to sensor node A1 is received via LMA-A 20. As described above, it is recognized that sensor node A1 is located in PAN-B, not PAN-A, based on binding cache information. Accordingly, the external IP data is no longer transmitted to PAN-A, and transmitted to coordinator node CFD-B of PAN-B through an IP-in-IP tunneling in operation 5830. The IP-in-IP tunneling is defined in a proxy Mobile IP.

In operation 5840, after coordinator node CFD-B receives the external IP data, an IP-in-IP tunneling packet is decapsulated. In operations 5850 and 5860, an optimal path is retrieved again using an ad-hoc routing protocol, and the external IP data is transmitted to coordinator node CFD-B from sensor node A1. In this instance, the ad-hoc routing protocol is calculated in a way reverse to an ad hoc routing of FIG. 2. That is, the optimal path to transmit the external IP data from coordinator node CFD-B to sensor node A1 is calculated as CFD-B→B2→A1. The external IP data is transmitted in an order of CFD-B→B2→A1. Thus, sensor node A1 may receive the external IP data without any interruption despite the movement to PAN-B.

A difference between the present invention and a conventional art is as follows:

A method of supporting mobility of a sensor node in a conventional art includes a method of managing mobility where a router provides a PBU message without signals to manage mobility of a computer terminal.

In the method of managing mobility of a sensor node in the conventional art, when the computer terminal moves into a link area managed by the router, the router transmits a PBU message to an LMA instead of the computer terminal. In this instance, an interval between the computer terminal and the router is one hop, and thus the movement is sensed through a simple link connectivity.

Conversely, according to the present invention, when a sensor node such as RFD or FFD moves into a new PAN, a coordinator node such as CFD controlling the PAN transmits a PBU signal instead of the sensor node. In this instance, an interval between the sensor node and the coordinator node is multiple hops, and thus the movement is sensed through an ad hoc routing scheme.

The difference between the present invention and conventional art is that the sensor node such as RFD or FFD and the coordinator node such as CFD are classified to manage mobility of the sensor node, the coordinator node transmits the PBU signal, and the movement of the sensor node is sensed by the ad hoc routing scheme between the sensor node and the coordinator node.

Thus, the present invention does not require an additional device such as a router, and may retrieve an optimal path between the sensor node and coordinator node since the ad hoc routing scheme is used to sense the sensor node and coordinator node. Also, registration information and external IP data may be transmitted via the optimal path.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. An apparatus for managing mobility of a sensor node in a personal area network (PAN), the apparatus comprising:
a sensor node sensing unit to sense a sensor node moving into the PAN from another PAN;
a proxy binding update (PBU) message generation unit to generate location change information of the sensed sensor node; and
a PBU message transmission unit to transmit the location change information.

2. The apparatus of claim 1, wherein the sensor node sensing unit senses the sensor node using an ad-hoc routing protocol.

3. The apparatus of claim 1, further comprising:
an external Internet Protocol (IP) data transceiving unit to receive external IP data according to the location change information and transmit the external IP data to the sensor node.

4. The apparatus of claim 3, wherein the external IP data is transmitted to the sensor node using an ad-hoc routing protocol.

5. An apparatus for managing mobility of a sensor node in a PAN, the apparatus comprising:
a location change information receiving unit to receive location change information of the sensor node from a coordinator node controlling the PAN;
a location information management unit to update location information of the sensor node according to the location change information; and
an external IP data transceiving unit to transmit external IP data to the coordinator node according to the updated location information.

6. The apparatus of claim 5, wherein the location information includes identification information of the sensor node and the PAN.

7. The apparatus of claim 5, wherein the external IP data transceiving unit transmits the external IP data to the coordinator node through an IP-in-IP tunneling.

8. A method of managing mobility of a sensor node in an IP-based PAN, the method comprising:
sensing a sensor node which moves into the PAN from an arbitrary PAN; and
generating and transmitting location change information of the sensed sensor node.

9. The method of claim 8, wherein the sensing comprises:
broadcasting, by the sensor node, a registration signal to neighbor sensor nodes; and
transmitting, by a neighbor sensor node in the neighbor sensor nodes receiving the registration signal, the registration signal to a coordinator node, the neighbor sensor node being in an optimal path to the coordinator node controlling the PAN.

10. A method of managing mobility of a sensor node which moves from an arbitrary PAN to another PAN, the method comprising:
receiving location change information of the sensor node;
updating location information of the sensor node based on the location change information; and
transmitting external IP data to a coordinator node, which controls the sensor node, by referring to the updated location information.

11. The method of claim 10, further comprising:
retrieving an optimal path to the sensor node using an ad hoc protocol, and
transmitting the external IP data to the sensor node via the retrieved optimal path.
